(19) United States
(12) Patent Application Publication
(10) Pub. No.: US 2003/0136589 A1
(43) Pub. Date: Jul. 24, 2003

(54) Conveyor belt scale system

(76) Inventor: James P. Dietrich, New Athens, IL (US)

Correspondence Address: Michael S. Neustel, Suite No. 4, 2534 South University Drive, Fargo, ND, 58103, US

(21) Appl. No.: 10/053,721

(22) Filed: Jan. 21, 2002

(51) Int. Cl. G01G 11/14

(52) U.S. Cl. 177/16

(57) ABSTRACT

A conveyor belt scale system for increasing the weight measurement accuracy of a conveyor belt scale. The conveyor belt scale system includes a conveyor having a support frame and a belt, a first load cell positioned within the conveyor for measuring the belt after receiving a load of material (full weight), a second load cell positioned within the conveyor for measuring the belt prior to receiving a load of material (empty weight), a velocity sensor within the conveyor for measuring the velocity of the belt, and a control unit in communication with the sensors. The control unit measures the empty weight and the full weight of the belt upon a plurality of locations upon the belt. The control unit corresponds the empty weight with the full weight of each of the measured locations to calculate the material net weight.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to conveyor belt scales and more specifically it relates to a conveyor belt scale system for increasing the weight measurement accuracy of a conveyor belt scale.

2. Description of the Prior Art

Conveyor belts scales for measuring the amount of material transported upon a conveyor belt have been in use for years. A conventional conveyor belt scale is positioned a finite distance along the conveyor belt after the location of depositing the material upon the conveyor belt. The conveyor belt scale must first be “zero calibrated” to determine the average weight of the belt. A control unit then subtracts the calculated average weight of the belt from the total weight read by the belt scale with a load to determine the approximate weight of the load. By simultaneously measuring the velocity of the conveyor belt, the total weight of material loaded and transported upon the conveyor belt may be approximately calculated.

The main problem with conventional conveyor belt scales is that they do not take into account that a conveyor belt typically has varying unloaded weights along the entire length. Conventional conveyor belt scales merely take into account the “average weight” of the belt when computing the weight of the loaded material.

Another problem with conventional conveyor belt scales is that they do not compensate for accumulated debris upon the conveyor belt during operation which over time increases the overall empty weight of the conveyor belt. Accumulated debris may include but is not limited to dirt, portions of the loaded material, moisture. Accumulated debris may also be in the “negative” wherein a portion of the conveyor belt has been accidentally removed thereby reducing the weight of the conveyor belt in that location. The solution for conventional conveyor belt scales is to terminate the loading of material upon the conveyor belt and “zero calibrate” the conveyor belt again. This must be performed repeatedly and is an inefficient usage of the conveyor belt.

While these devices may be suitable for the particular purpose to which they address, they are not as suitable for increasing the weight measurement accuracy of a conveyor belt scale. Conventional conveyor belt scales are not extremely accurate and are prone to errors caused by location weight differences within the conveyor belt and accumulated debris.

In these respects, the conveyor belt scale system according to the present invention substantially departs from the conventional concepts and designs of the prior art, and in so doing provides an apparatus primarily developed for the purpose of increasing the weight measurement accuracy of a conveyor belt scale.

### SUMMARY OF THE INVENTION

In view of the foregoing disadvantages inherent in the known types of conveyor belt scales now present in the prior art, the present invention provides a new conveyor belt scale system construction wherein the same can be utilized for increasing the weight measurement accuracy of a conveyor belt scale.

The general purpose of the present invention, which will be described subsequently in greater detail, is to provide a new conveyor belt scale system that has many of the advantages of the conveyor belt scales mentioned heretofore and many novel features that result in a new conveyor belt scale system which is not anticipated, rendered obvious, suggested, or even implied by any of the prior art conveyor belt scales, either alone or in any combination thereof.

To attain this, the present invention generally comprises a conveyor having a support frame and a belt, a first load cell positioned within the conveyor for measuring the belt after receiving a load of material (full weight), a second load cell positioned within the conveyor for measuring the belt prior to receiving a load of material (empty weight), a velocity sensor within the conveyor for measuring the velocity of the belt, and a control unit in communication with the sensors. The control unit measures the empty weight and the full weight of the belt upon a plurality of locations upon the belt. The control unit corresponds the empty weight with the full weight of each of the measured locations to calculate the material net weight.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a conveyor belt scale system that will overcome the shortcomings of the prior art devices.

A second object is to provide a conveyor belt scale system for increasing the weight measurement accuracy of a conveyor belt scale.

Another object is to provide a conveyor belt scale system that constantly calculates the empty weight of specific locations of a conveyor belt during operation of the belt.

An additional object is to provide a conveyor belt scale system that does not require repeated stoppage of the conveyor belt.

A further object is to provide a conveyor belt scale system that can be utilized upon various types of conveyor belts and retrofitted easily to existing conveyor belt scale systems.

Another object is to provide a conveyor belt scale system that is capable of compensating for dynamic changes in the empty weight of a conveyor belt while the belt is in a continuous loaded state.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a side view of the present invention.

FIG. 2 is a block diagram of the present invention.

FIG. 3 is an upper perspective view of the present invention.

FIG. 4 is a cross sectional view taken along line 4-4 of FIG. 3.

FIG. 5 is a magnified side view of the present invention with a load positioned upon the conveyor belt.

FIG. 6 is a magnified upper perspective view of the second load cell supporting the lower roller.

FIG. 7 is a side view of an alternative embodiment wherein the second load cell is positioned within the upper portion of the belt prior to entry of the material.

FIG. 8 is a chart providing an example of the data and calculations received and performed by the control unit.

### DESCRIPTION OF THE PREFERRED EMBODIMENT

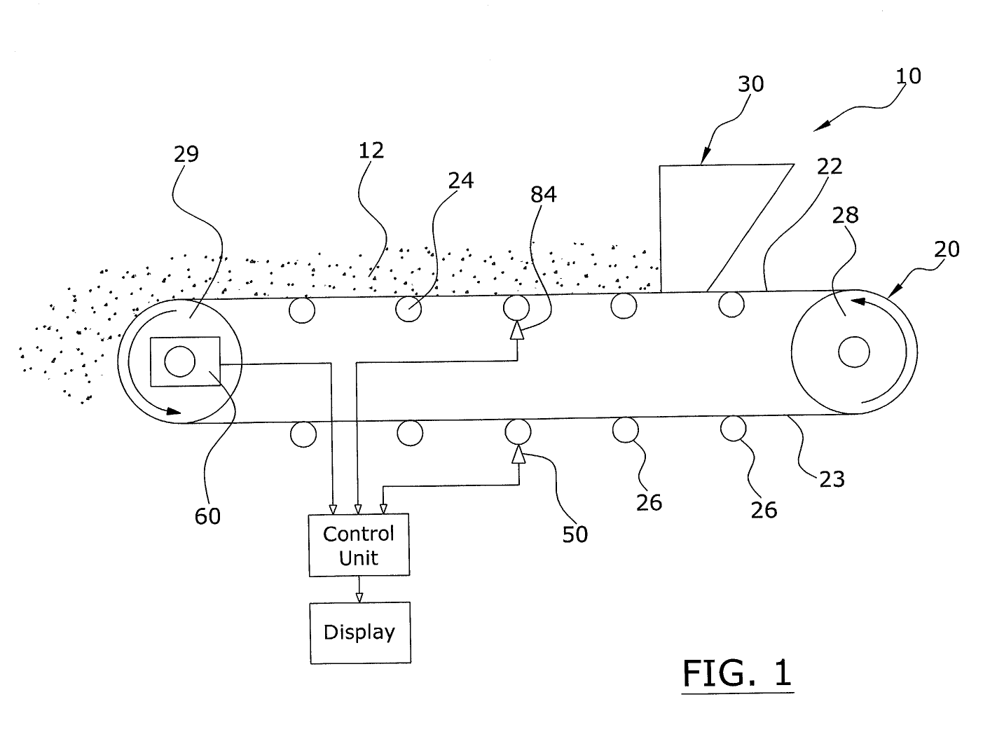

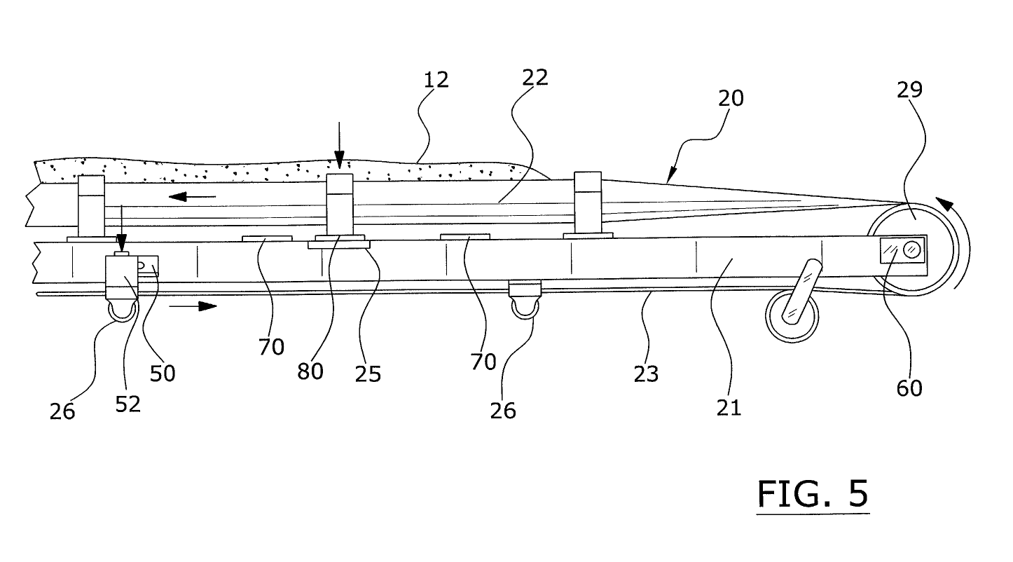

Turning now descriptively to the drawings, in which similar reference characters denote similar elements throughout the several views, FIGS. 1 through 8 illustrate a conveyor belt scale system 10, which comprises a conveyor having a support frame 21 and a belt 20, a first load cell 40 positioned within the conveyor for measuring the belt 20 after receiving a load of material 12 (full weight), a second load cell 50 positioned within the conveyor for measuring the belt 20 prior to receiving a load of material 12 (empty weight), a velocity sensor 60 within the conveyor for measuring the velocity of the belt 20, and a control unit 42 in communication with the sensors. The control unit 42 measures the empty weight and the full weight of the belt 20 upon a plurality of locations upon the belt 20. The control unit 42 corresponds the empty weight with the full weight of each of the measured locations to calculate the material 12 net weight.

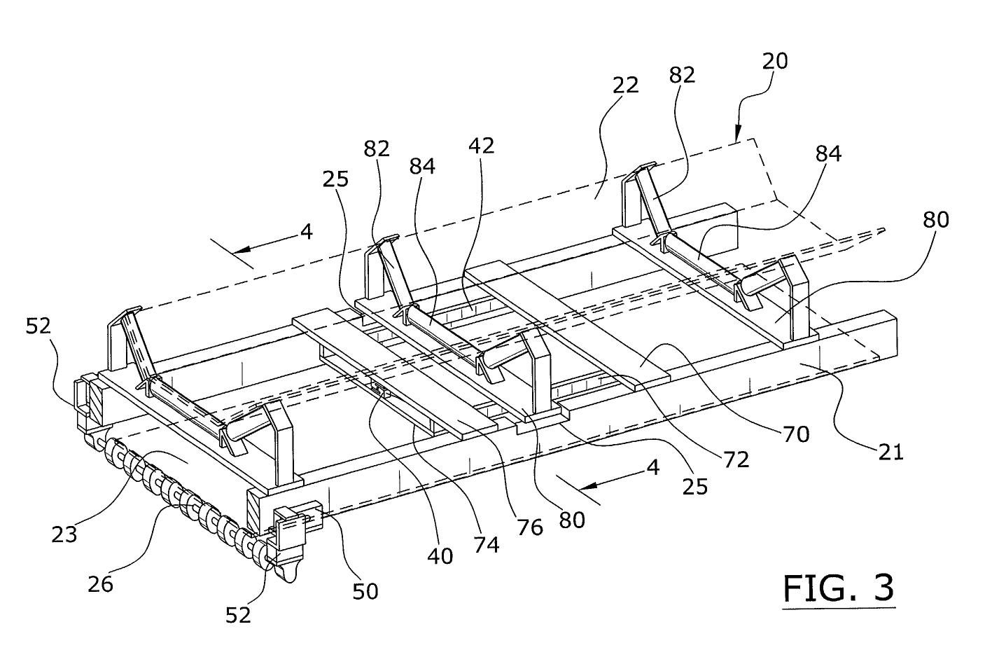

As shown in FIGS. 3, 5 and 7 of the drawings, the conveyor is comprised of an elongate support frame 21 with an endless belt 20 rotatably positioned upon the support frame 21 in a longitudinal manner. A first end roller 28 and a second end roller 29 rotatably attached to the support frame 21 allow the belt 20 to rotatably travel continuously upon the conveyor. A conventional drive motor is connected to at least one of the rollers for driving the endless belt 20 as is well established in the art.

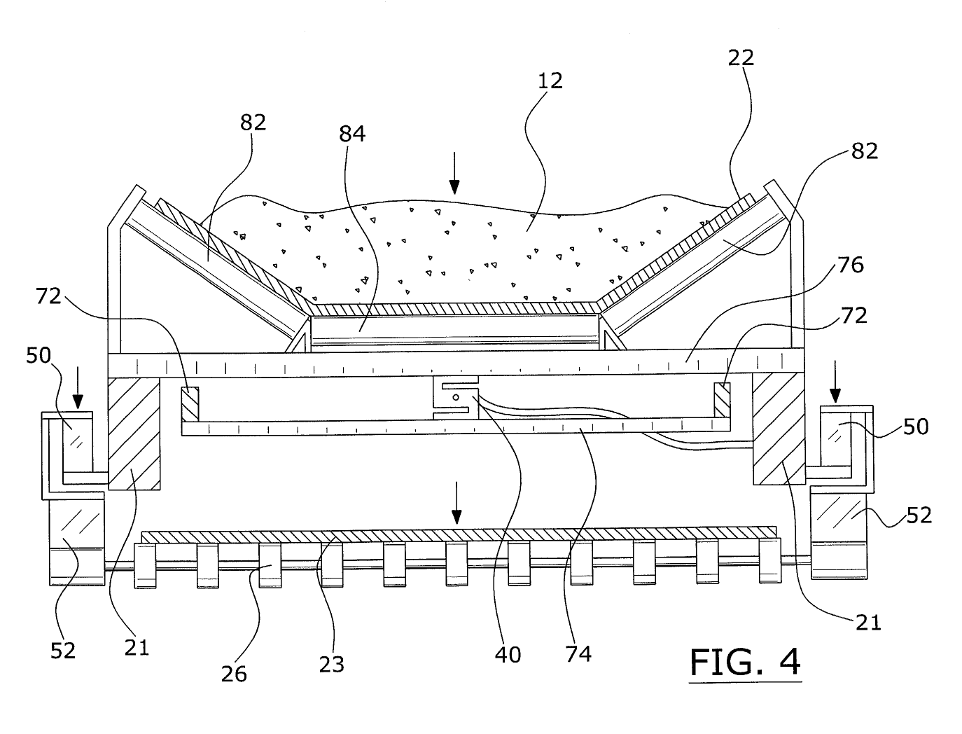

A plurality of rollers 82, 84 are rotatably positioned within the support frame 21 for supporting the upper portion 22 of the belt 20 as shown in FIGS. 3 and 4 of the drawings. The plurality of rollers 82, 84 may have various structures such as flat, U-shape, V-shaped and the like. FIGS. 3 and 4 illustrate the usage of a pair of side rollers 82 and a middle roller 84 rotatably attached to a cross member 80 and support structure extending from the cross member 80. It can be appreciated that the upper roller structure for the conveyor may be comprised of various other roller structures not illustrated within the figures. As further shown in FIGS. 3, 4, 5 and 7 of the drawings, a plurality of lower rollers 26 are rotatably attached to the support frame 21 for supporting the lower portion 23 of the endless belt 20 during the non-load phase. The exemplary conveyor may have various other structures other than that illustrated within the figures as can be appreciated.

As further shown in FIGS. 3, 5 and 7 of the drawings, the belt 20 has an upper portion 22 (load side) and a lower portion 23 (non-load side). The endless belt 20 may have a flat shape, curved shape or other shape commonly utilized within conventional conveyors for transporting material 12 and items. The endless belt 20 may include various additional structures commonly utilized with endless belts. The endless belt 20 may also be comprised of various types of flexible materials that are well known in the conveyor industry.

As shown in FIG. 1 of the drawings, a first load cell 40 is positioned to measure the weight of the upper portion 22 of the endless belt 20 transporting the material 12. The first load cell 40 may be positioned at various locations along the upper portion 22 of the endless track after the location of the material dispenser 30. The first load cell 40 measures the combined weight of a position upon the endless belt 20 and the material 12 being transported. The first load cell 40 may be attached as a pivoted or full floating suspension system.

FIG. 3 illustrates the usage of a first member 70 and a second member 76 attached about the support frame 21 traverse to the endless belt 20. A pair of support members 72 are pivotally attached to the first member 70 as best shown in FIG. 3 of the drawings. The support members 72 pivotally extend from the first member 70 and are connected to a lower member 74 positioned directly below the second member 76 as shown in FIG. 4 of the drawings. The lower member 74 is attached to the lower surface of the second member 76 by the first load cell 40 as shown in FIG. 4 of the drawings. A cross member 80 supporting a pair of side rollers 82 and a middle roller 84 is attached to the support members 72 near the second member 76 as shown in FIG. 3 of the drawings. A pair of cutouts 25 within the side members of the support frame 21 allow the cross member 80 attached to the support members 72 to freely move upwardly and downwardly based upon the weight of the belt 20 and material 12. The first load cell 40 calculates the downward force applied to the support members 72 to calculate the gross weight of a position upon the endless belt 20 containing the material 12 (gross full weight). The first load cell 40 is preferably comprised of a tension load cell structure, but may be comprised of a compression load cell structure by repositioning the first load cell 40 with respect to the lower member 74 so that the first load cell 40 is positioned non-movably with respect to the support frame 21 such as by a brace member or the like.

As further shown in FIG. 1 of the drawings, a second load cell 50 is positioned to measure the weight of the lower portion 23 of the endless belt 20. The second load cell 50 may be positioned at various locations along the lower portion 23 of the endless track after the material 12 has been removed from the upper portion 22 of the belt 20. The second load cell 50 measures the “empty” weight of a position upon the endless belt 20 (gross empty weight). The second load cell 50 may be comprised of a tension or compression load cell structure.

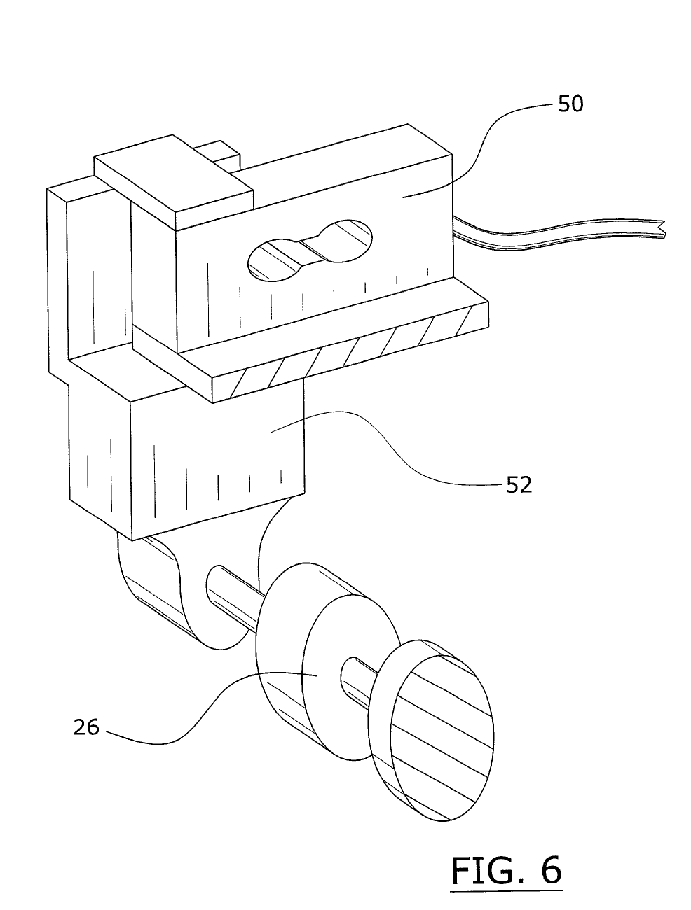

As shown in FIGS. 3 and 4 of the drawings, a pair of second load cells 50 are preferably attached to and supporting one or more of the lower rollers 26 by a pair of brackets 52. As shown in FIG. 6 of the drawings, the upper load cell is attached to the side of the support frame 21 is the bracket is applying a compression force upon the second load cell 50. It can be appreciated that the second load cell 50 may be comprised of a tension load cell design by reconfiguring the position of the bracket and the second load cell 50.

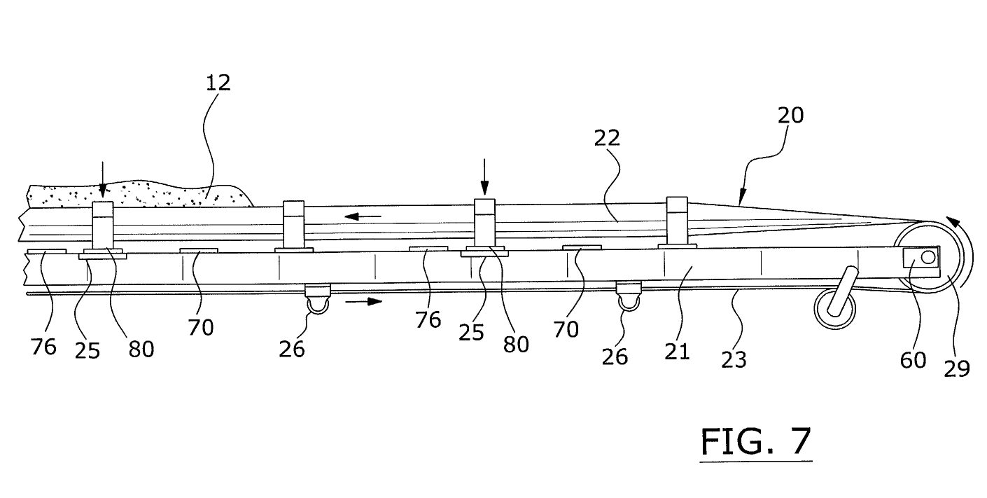

FIG. 7 illustrates an alternative embodiment of the present invention wherein the second load cell 50 is positioned with respect to the upper portion 22 of the endless belt 20 prior to entry of the material 12 to measure the empty weight of the belt 20. Similar to the first load cell 40 structure, FIG. 7 illustrates the usage of a first member 70 and a second member 76 attached about the support frame 21 traverse to the endless belt 20. A pair of support members 72 are pivotally attached to the first member 70 similar to that shown in FIG. 3 of the drawings. The support members 72 pivotally extend from the first member 70 and are connected to a lower member 74 positioned directly below the second member 76 similar to that shown in FIG. 4 of the drawings. The lower member 74 is attached to the lower surface of the second member 76 by the first load cell 40. A cross member 80 supporting a pair of side rollers 82 and a middle roller 84 is attached to the support members 72 near the second member 76 similar to that shown in FIG. 3 of the drawings. A pair of cutouts 25 within the side members of the support frame 21 allow the cross member 80 attached to the support members 72 to freely move upwardly and downwardly based upon the weight of the belt 20 and material 12 as shown in FIG. 7. The second load cell 50 calculates the downward force applied to the support members 72 to calculate the gross weight of a position upon the endless belt 20 (gross empty weight). The second load cell 50 is preferably comprised of a tension load cell structure, but may be comprised of a compression load cell structure by repositioning the second load cell 50 with respect to the lower member 74 so that the second load cell 50 is positioned non-movably with respect to the support frame 21 such as by a brace member or the like. The advantage of the alternative embodiment is that the measurement of the gross empty weight occurs closer to the measurement of the gross full weight thereby reducing the likelihood of changes in the gross empty weight prior to measuring the gross full weight.

As shown in FIG. 1 of the drawings, a velocity sensor 60 is connected to the first end roller 28. The velocity sensor 60 measures the rotational velocity of the first end roller 28 and by using the known diameter of the first end roller 28 the control unit 42 is able to calculate the longitudinal velocity of the belt 20. It can be appreciated that various other known sensors may be utilized to measure and calculate the velocity of the endless belt 20.

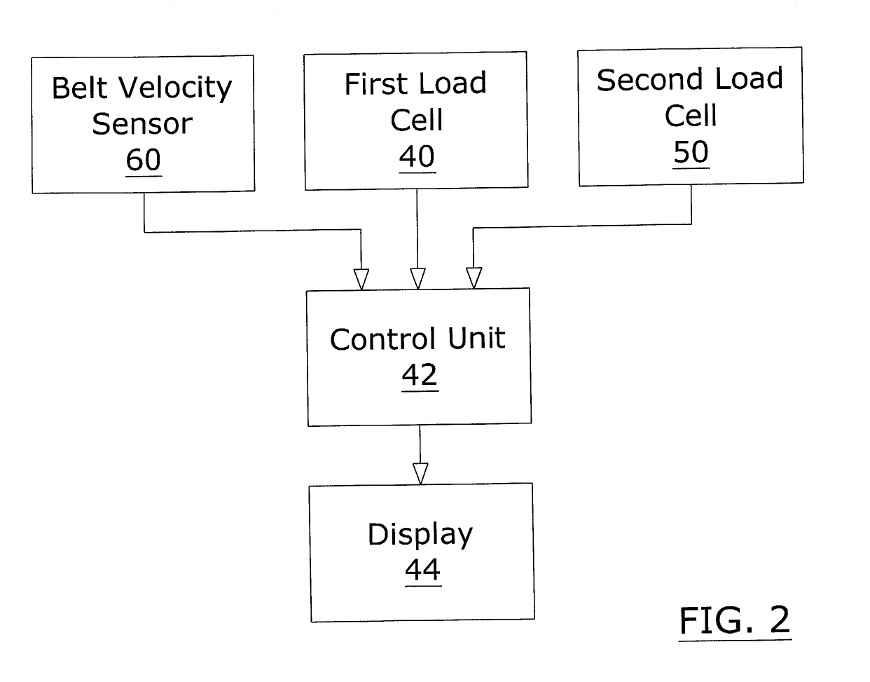

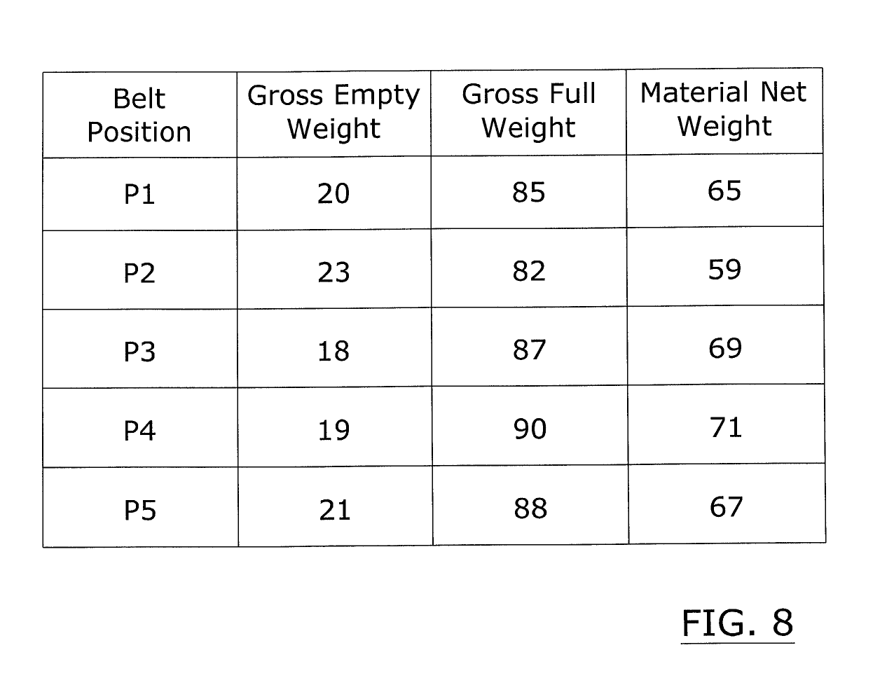

As shown in FIG. 2 of the drawings, the control unit 42 is in communication with the velocity sensor 60, the first load cell 40 and the second load cell 50. The sensors 40, 50 and 60 may be in communication with the control unit 42 via various communication means such as wireless, electrical wire and the like. The control unit 42 is capable of performing taring calculations and the like utilizing a computer or similar electronic design which are well-known in the art. The control unit 42 is able to monitor specific locations upon the endless belt 20 by using the data received from the velocity sensor 60 thereby eliminating the need for a “marker” upon the endless belt 20. The control unit 42 first receives a measurement of the gross empty weight upon a position P1 from the second load cell 50. By using the velocity data from the velocity sensor 60 along with know distance parameters, the control unit 42 is able to calculate when position P1 is directly above the supporting rollers 82, 84 that are applying a downward force upon the first load cell 40. The control unit 42 then receives a measurement of the gross full weight of position P1 from the first load cell 40. The control unit 42 is able to subtract the gross empty weight from the gross full weight of position P1 to calculate the net weight of the material 12 being loaded and transported upon the upper portion 22 of the belt 20 as shown in the example of FIG. 8. It can be appreciated that a plurality of positions (P1, P2, P3, P4, P4 . . . Pn) are measured by the control unit 42 along the endless belt 20. This process continues during the entire operation of the conveyor until the conveyor is terminated. The control unit 42 can increase the accuracy of the net weight measurement by increasing the total number of positions measured along the length of the endless belt 20. As is well known in the art, the calculated net weight of the material 12 is utilized in conjunction with the measured velocity of the endless belt 20 to calculate the total material 12 loaded and transported upon the endless belt 20 over a period of time which may be shown upon the display 44 or other device.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A conveyor belt scale system, comprising:
a conveyor having a support frame and an endless belt rotatably supported about said support frame;
an upper roller supporting an upper portion of said endless belt after a material deposit location upon said endless belt;
a first load cell mechanically connected to said upper roller for measuring a gross full weight at a plurality of positions upon an upper portion of said endless belt supporting material deposited;
a lower roller support a lower portion of said endless belt after said material is removed from said endless belt;
a second load cell mechanically connected to said lower roller for measuring a gross empty weight at said plurality of positions upon a lower portion of said endless belt;
a velocity sensor measuring a velocity of said endless belt; and
a control unit in communication with said load cells and said velocity sensor for receiving a gross empty weight and a gross full weight of a specific position upon said endless belt for calculating a net weight of material transported upon said conveyor.

2. The conveyor belt scale system of claim 1, including:
a first member attached to said support frame;
a second member attached to said support frame;
a plurality of support members pivotally attached to said first member and extending beneath said second member;
a cross member attached to said plurality of support members and rotatably supporting said upper roller; and
a lower member attached to distal portions of said plurality of support members, wherein said first load cell is connected between said lower member and a lower surface of said second member.

3. The conveyor belt scale system of claim 2, wherein said first load cell is comprised of a tension load cell.

4. The conveyor belt scale system of claim 3, including a plurality of cutouts within said support frame for movably receiving distal portions of said cross member.

5. The conveyor belt scale system of claim 4, wherein said upper roller is comprised of a middle roller and a pair of side rollers extending outwardly and upwardly.

6. The conveyor belt scale system of claim 5, wherein said upper roller is positioned at least three feet after a deposit location of said material upon said endless belt.

7. The conveyor belt scale system of claim 1, wherein said second load cell is comprised of:
a pair of side load cells attached to said support frame; and
a pair of brackets attached to said side load cells extending downwardly and rotatably supporting said lower roller.

8. The conveyor belt scale system of claim 7, wherein said side load cells are comprised of a compression load cell structure.

9. The conveyor belt scale system of claim 1, including a display for displaying said net weight.

10. The conveyor belt scale system of claim 1, wherein said lower roller is positioned near a transition location of said endless belt from said lower portion to said upper portion.

11. A conveyor belt scale system , comprising:
a conveyor having a support frame and an endless belt rotatably supported about said support frame;
an upper roller supporting an upper portion of said endless belt after a material deposit location upon said endless belt;
a first load cell mechanically connected to said upper roller for measuring a gross full weight at a plurality of positions upon an upper portion of said endless belt supporting material deposited;
a lower roller support a lower portion of said endless belt after said material is removed from said endless belt;
a second load cell mechanically connected to a second upper roller for measuring a gross empty weight at said plurality of positions upon said upper portion of said endless belt prior to a material deposit location;
a velocity sensor measuring a velocity of said endless belt; and
a control unit in communication with said load cells and said velocity sensor for receiving a gross empty weight and a gross full weight of a specific position upon said endless belt for calculating a net weight of material transported upon said conveyor.

12. The conveyor belt scale system of claim 11, including:
a first member attached to said support frame;
a second member attached to said support frame;
a plurality of support members pivotally attached to said first member and extending beneath said second member;
a cross member attached to said plurality of support members and rotatably supporting said upper roller; and
a lower member attached to distal portions of said plurality of support members, wherein said first load cell is connected between said lower member and a lower surface of said second member.

13. The conveyor belt scale system of claim 12, wherein said first load cell is comprised of a tension load cell.

14. The conveyor belt scale system of claim 13, including a plurality of cutouts within said support frame for movably receiving distal portions of said cross member.

15. The conveyor belt scale system of claim 14, wherein said upper roller is comprised of a middle roller and a pair of side rollers extending outwardly and upwardly.

16. The conveyor belt scale system of claim 15, wherein said upper roller is positioned at least three feet after a deposit location of said material upon said endless belt.

17. The conveyor belt scale system of claim 11, including:
a first member attached to said support frame;
a second member attached to said support frame;
a plurality of support members pivotally attached to said first member and extending beneath said second member;
a cross member attached to said plurality of support members and rotatably supporting said upper roller; and
a lower member attached to distal portions of said plurality of support members, wherein said second load cell is connected between said lower member and a lower surface of said second member.

18. The conveyor belt scale system of claim 17, wherein said second load cell is comprised of a tension load cell.

19. The conveyor belt scale system of claim 11, wherein said lower roller is positioned near and before said material deposit location upon said upper portion of said endless belt.

20. A method of calculating a material net weight upon a conveyor having an endless belt with a first measuring location and a second measuring location, said method comprising the steps of:
(a) measuring a velocity of said endless belt in a continuous manner;
(b) measuring a gross empty weight of said endless belt at a position P1 at said first measuring location;
(c) calculating when position P1 of said endless belt will be positioned upon said second measuring location based upon said velocity of said endless belt;
(d) repeating steps (a), (b) and (c) for another plurality of positions upon said endless belt;
(e) measuring a gross full weight of said endless belt at position P1 at said second measuring location;
(f) calculating a material net weight at position P1 by subtracting said gross empty weight from said gross full weight;
(g) repeating step (f) for remaining plurality of positions upon said endless belt; and
(h) repeating steps (a) through (g).
